(19) United States
(12) Patent Application Publication
(10) Pub. No.: US 2024/0021796 A1
(43) Pub. Date: Jan. 18, 2024

(54) MECHANICAL PULVERIZATION OF COBALT-FREE NICKEL-RICH CATHODES

(71) Applicant: Alliance for Sustainable Energy, LLC, Golden, CO (US)

(72) Inventors: Ryan Ray BROW, Denver, CO (US); Shriram SANTHANAGOPALAN, Broomfield, CO (US); Alexis Rose LUGLIO, Wayne, NJ (US)

(21) Appl. No.: 18/050,124

(22) Filed: Oct. 27, 2022

Related U.S. Application Data
(60) Provisional application No. 63/276,011, filed on Nov. 5, 2021.

(51) Int. Cl. H01M 4/36; H01M 4/131; H01M 4/505; H01M 4/525; H01M 4/58; C01G 53/00

(52) U.S. Cl. CPC H01M 4/366; H01M 4/131; H01M 4/505; C01P 2006/40; H01M 4/5825; C01G 53/50; H01M 4/525

(57) ABSTRACT

The present disclosure relates to mitigation strategies to limit particle fracture and surface degradation caused by air instability. Some embodiments include cobalt-free nickel-rich NMA (LiNi_{0.9}Mn_{0.5}Al_{0.05}O₂) being ball-milled to effectively “pre-crack” the secondary particles into their primary constituents or single crystallites. These NMA particles may be coated with lithium phosphate and/or phosphoric acid. After approximately 100 cycles, these pulverized NMA particles showed delay voltage decay and approximately double the discharge capacity compared to traditional pristine NMA cathode materials during high-voltage cycling.

### CROSS-REFERENCE TO RELATED APPLICATIONS

This application claims the benefit of U.S. Provisional Application No. 63/276,011 filed on Nov. 5, 2021, the contents of which are incorporated herein by reference in their entirety.

### CONTRACTUAL ORIGIN

This invention was made with United States government support under Contract No. DE-AC36-08GO28308 awarded by the U.S. Department of Energy. The United States government has certain rights in this invention.

### BACKGROUND

Lithium-ion batteries are at the forefront of the coming electric vehicle revolution due to their relatively high specific and volumetric capacity, longevity, and plummeting costs. A typical commercial battery has a transition metal (TM) oxide as its cathode, with lithium cobalt oxide (LiCoO₂) being the first widely available and most successful transition metal oxide cathode. However, LiCoO₂ suffers from low practical capacity, safety concerns, unreliable raw material sourcing, and high costs. Therefore, there has been an effort to decrease the cost and increase the capacity of these cathodes by replacing cobalt (Co) with nickel (Ni), when possible.

Nickel can readily oxidize to its Ni^{3+/4+} oxidation state since its energy band does not overlap with that of the O²⁻:2p band in TM oxide cathodes. The same cannot be said for cobalt, as its Co^{3+/4+} overlaps with the O²⁻:2p band. This overlap causes oxygen to be released from the TM oxide structure when Li₁₋ₓCoO₂ is delithiated beyond 50% (i.e., x>0.5) when charging, thus limiting its practical capacity to about 140 mAh/g. Nickel is also lower cost and has more reliable raw material sourcing than cobalt. Unfortunately, these nickel-rich cathode materials experience cycle life reduction due to several factors, including electrolyte induced surface nickel reduction, particle fracture, air instability, and cation mixing. Ni⁴⁺ can undergo reduction by carbonate electrolytes and form nickel oxide-type rock-salt phase impurities which remove active sites and impede facile lithium-ion transport. Particle fracture is induced between weakly bound primary particles (i.e., NMA cathode material particles with a size of approximately 10 μm, or greater than about 3 μm) in the secondary particle (i.e., NMA cathode material particles with a size of less than approximately 1 μm) structure due to anisotropic lattice expansion/contraction during lithiation/delithiation. This leads to fracture at the grain boundary, and infiltration of electrolyte which reduces Ni⁴⁺ and leads to more phase impurity and active-site loss. Residual lithium compounds (Li₂O, LiOH, and Li₂CO₃) can form on nickel-rich cathode material surfaces via exposure to air during material synthesis and electrode processing causing gelation of electrode slurry and gas generation on cycling. Finally, due to the similarity in radius of Ni²⁺ and Li⁺, Ni²⁺ can be incorporated into the active sites and reduce lithium transport in the layered structure.

To mitigate the above issues, several strategies have been attempted: doping, surface modification, surface modification via intentional electrolyte additive decomposition, process refinement, TM concentration gradient, core-shell structures, grain boundary tailoring, and single crystalline morphology. These modifications have failed to generate nickel-rich cathode material with satisfactory cycle life retention and air stability for commercial use. Particle cracking still occurs with high voltage cycling, slowly degrading performance, and air instability allows residual lithium compounds to form during material synthesis and electrode production. Therefore, there exists a need for a mitigation strategy to limit particle fracture and surface degradation caused by air instability.

### SUMMARY

An aspect of the present disclosure is a method including pulverizing a pristine LiNi_{0.9}Mn_{0.5}Al_{0.05}O₂(NMA) cathode material resulting in a pulverized NMA cathode material and applying a coating on the pulverized NMA cathode material resulting in a coated pulverized NMA cathode material. In some embodiments, the method also includes combining the coated pulverized NMA cathode material with the pristine NMA cathode material resulting in a bimodal NMA cathode material. In some embodiments, the method also includes utilizing the bimodal NMA cathode material in a lithium-ion battery. In some embodiments, the lithium-ion battery retains at least 50% of its capacity retention after 100 cycles at C/3. In some embodiments, the lithium-ion battery retains at least 80% of its capacity retention after 100 cycles at C/3. In some embodiments, the bimodal cathode material includes the pristine NMA cathode material and the coated pulverized NMA cathode material combined in a ratio in the range of about 50:50 to about 95:5. In some embodiments, the bimodal cathode material includes the pristine NMA cathode material and the coated pulverized NMA cathode material combined in a ratio of approximately 80:20. In some embodiments, the method includes utilizing the coated pulverized NMA cathode material in a lithium-ion battery. In some embodiments, the pulverizing includes grinding the pristine NMA cathode material using a ball mill. In some embodiments, the pulverizing includes grinding the pristine NMA cathode material using a roller mill. In some embodiments, the pulverizing includes crushing the pristine NMA cathode material. In some embodiments, the applying includes exposing the pulverized NMA cathode material to phosphoric acid, in which the exposing results in the coating comprising lithium phosphate to be present on the pulverized NMA cathode material. In some embodiments, the applying includes using vapor deposition to deposit the coating on the pulverized NMA cathode material. In some embodiments, the coating includes at least one of lithium phosphate, aluminum oxide, or aluminum fluoride.

An aspect of the present disclosure is a lithium-ion battery device including a cathode comprising a coated pulverized NMA cathode material. In some embodiments, the lithium-ion battery retains at least 50% of its capacity retention after 100 cycles at C/3. In some embodiments, the lithium-ion battery retains at least 80% of its capacity retention after 100 cycles at C/3. In some embodiments, the cathode further includes a pristine NMA cathode material, resulting in a bimodal cathode material. In some embodiments, the bimodal cathode material includes the coated pulverized NMA cathode material and the pristine NMA cathode material in a ratio in the range of about 50:50 to about 95:5. In some embodiments, the bimodal cathode material includes the coated pulverized NMA cathode material and the pristine NMA cathode material in the ratio of approximately 80:20.

### BRIEF DESCRIPTION OF THE DRAWINGS

Some embodiments of the present disclosure are illustrated in the referenced figures of the drawings. It is intended that the embodiments and figures disclosed herein are to be considered illustrative rather than limiting.

FIG. 1 illustrates a method of preparing an electrode using pulverized (LiNi_{0.9}Mn_{0.5}Al_{0.05}O₂) (NMA) materials, according to some aspects of the present disclosure.

FIG. 2 illustrates scanning electron microscope (SEM) images of pulverized NMA cathode materials, according to some aspects of the present disclosure.

FIG. 3 illustrates transmission electron microscopy (TEM) images of the lithium phosphate coatings on pulverized NMA cathode materials, according to some aspects of the present disclosure.

FIG. 4 illustrates x-ray photoelectron spectroscopy (XPS) data for lithium phosphate coated and uncoated NMA cathode materials, according to some aspects of the present disclosure.

FIG. 5 illustrates electrochemical impedance spectroscopy (EIS) data (i.e., a Nyquist plot) for lithium phosphate coated and uncoated NMA cathode materials after approximately 125 cycles, according to some aspects of the present disclosure.

FIG. 6 illustrates initial cycling data for lithium phosphate coated and uncoated NMA cathode materials, according to some aspects of the present disclosure.

FIG. 7 illustrates half-cell cycling data for lithium phosphate coated and uncoated NMA cathode materials, according to some aspects of the present disclosure.

FIG. 8 illustrates full cell cycling data for lithium phosphate coated and uncoated NMA cathode materials, according to some aspects of the present disclosure.

FIG. 9 illustrates specific capacity as a function of the cycle number for substantially uncalendared bimodal and unimodal cells, according to some aspects of the present disclosure.

FIG. 10 illustrates specific capacity as a function of the cycle number for approximately 40% calendared (top), and approximately 30% calendared (bottom) bimodal and unimodal cells, according to some aspects of the present disclosure.

FIG. 11 illustrates x-ray diffraction (XRD) data comparing unimodal and bimodal uncalendared and calendared (approximately 30% porosities) samples at full spectrum, according to some aspects of the present disclosure.

FIG. 12 illustrates XRD data comparing unimodal and bimodal uncalendared and calendared (approximately 30% porosities) samples at 003 (top) and 006/012 (bottom) peaks, according to some aspects of the present disclosure.

FIG. 13 illustrates a focused ion beam cross-sectional SEM image of an approximately 30% calendared bimodal NMA cathode material, according to some aspects of the present disclosure.

FIG. 14 illustrates a Nyquist plot of bimodal calendared and approximately 30% uncalendared half cells after the fifth formation cycle (top) and after approximately 100 cycles (bottom), according to some aspects of the present disclosure.

FIG. 15 illustrates a Nyquist plot of unimodal approximately 30% calendared and unimodal uncalendared half cells after the fifth formation cycle (top) and after approximately 100 cycles (bottom), according to some aspects of the present disclosure.

### DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments even if not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present disclosure, the term “substantially” is defined as approaching a specific numeric value or target to within 20%, 15%, 10%, 5%, or within 1% of the value or target. In further embodiments of the present disclosure, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present disclosure, the term “about” is used to indicate an uncertainty limit of less than or equal to ±20%, ±15%, ±10%, ±5%, or ±1% of a specific numeric value or target. In some embodiments of the present disclosure, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

Among other things, the present disclosure relates to mitigation strategies to limit particle fracture and surface degradation caused by air instability. Some embodiments include cobalt-free nickel-rich NMA (LiNi_{0.9}Mn_{0.5}Al_{0.05}O₂) being ball-milled to effectively “pre-crack” the secondary particles into their primary constituents or single crystallites. Then, these NMA particles may be coated with lithium phosphate and/or phosphoric acid. After approximately 100 cycles, these pulverized NMA particles showed delay voltage decay and approximately double the discharge capacity compared to traditional pristine NMA cathode materials during high-voltage cycling.

As used herein, “pristine” means substantially unused (i.e., uncycled) and/or substantially new material, which is relatively free of damage from typically wear and tear. For example, pristine NMA material refers to NMA material which has not be used in a functional (i.e., working) electrode. Pristine NMA may be of any quality of manufacture and may have defects from the manufacturing process but does not have damage from being used in an electrode.

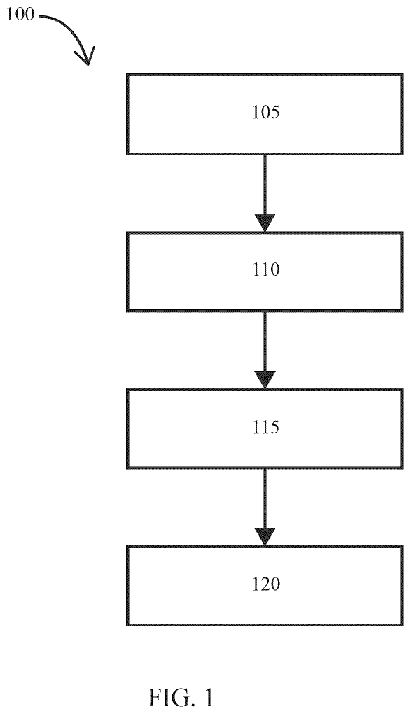

FIG. 1 illustrates a method 100 of preparing an electrode using pulverized (LiNi_{0.9}Mn_{0.5}Al_{0.05}O₂) (NMA) materials, according to some aspects of the present disclosure.

The method 100 first including pulverizing 105 the pristine NMA cathode material resulting in a pulverized NMA cathode material. The pulverizing 105 may include grinding, crushing, cracking, or breaking the pristine NMA cathode material into smaller pieces. The pulverizing 105 may break the pristine NMA cathode material's secondary particles (i.e., pristine particles) down into primary particles. The pulverizing 105 may be done using a ball-mill, roller mill, or other similar means.

The method 100 next includes applying 110 a coating to the pulverized NMA cathode material resulting in a coated pulverized NMA cathode material. The applying 110 may be done by exposing the pulverized NMA cathode material to an acid or an acid precursor (for example, phosphoric acid) which may react with the pulverized NMA cathode material's exposed surfaces, to form the coating. The applying 110 may include using vapor deposition (including atomic vapor deposition), spraying, brushing, or other processes.

In some embodiments, the method 100 next includes combining 115 the coated pulverized NMA cathode material with the pristine NMA cathode material resulting in a bimodal cathode material. The combining 115 may be done in a ratio of pristine NMA cathode material to coated pulverized NMA cathode material in the range of about 40:60 to about 99:1. In some embodiments, the ratio of pristine NMA cathode material to coated pulverized NMA cathode material may be approximately 80:20.

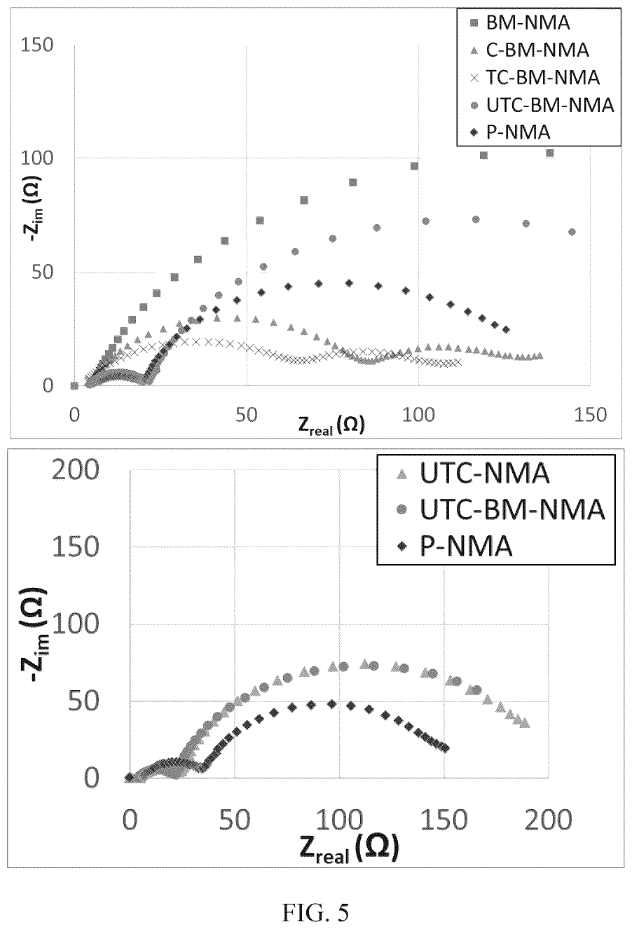

In some embodiments, the method 100 next includes utilizing 120 the coated pulverized NMA cathode material in an electrode. In some embodiments, the utilizing 120 also includes a volume of pristine NMA cathode material combined 115 as described above. Electrodes utilizing 120 the coated pulverized NMA cathode material may exhibit improved performance over entirely pristine electrodes, as shown in FIGS. 5-11 and 13.

For experiments, a high-energy, planetary ball-milling process was employed to pulverize 105 cathode active materials into a relatively uniform nanostructure. An approximately 1:10 weight ratio of cathode active material (approximately 5 g of NMA) and zirconium oxide (ZrO₂) spheres (approximately 50 g with an average diameter of approximately 3 mm), where inserted into a ZrO₂ vessel (volume of approximately 25 mL) and sealed in a substantially argon atmosphere. The chamber was fixed inside a Retsch PM 200 planetary mill and operated at speeds in the range of about 300 rpm to about 600 rpm, selecting about 450 rpm as the primary speed for this experiment. However, other speeds could be used. The milling procedure included grinding and rest time of approximately 60 seconds and approximately 20 seconds, respectively, and included a reversal of rotation direction after each rest. Milling times in the range of about 30 minutes to about 240 minutes were attempted. An operational time of approximately 75 minutes was selected to achieve substantially homogeneous nano-scale primary particles as assessed by scanned electron microscope (SEM) herein.

For the lithium phosphate coatings, they were applied 110 using a diffusion-controlled reaction with phosphoric acid in an ethanol solution. Phosphoric acid and substantially pristine NMA of varying weight ratios were mixed with anhydrous ethanol in an argon glovebox. The solution was brought to approximately 85° C. while stirred until the solvent evaporated. The dried powder was then loaded into a tube furnace and heated to approximately 500° C. for approximately 5 hours in ambient air.

The coated and uncoated NMA (approximately 90 wt %) was mixed with carbon black (approximately 5 wt %) and polyvinylidene fluoride (PVDF) (approximately 5 wt %) in NMP and mixed for approximately 3 minutes using a variable speed mixer. The slurry was then coated onto aluminum foil using a surgical blade and placed in a vacuum oven to be substantially dried overnight (approximately 12 hours) at about 100° C. The electrodes were then weighted and assembled into either half or full coin cells in an argon glovebox with less than approximately 0.1 ppm water and oxygen (O₂). The cells were assembled using a Gen-2 electrolyte and cycled (i.e., utilized 120) at approximately room temperature. Change and discharge steps were performed under substantially constant current conditions without a voltage step (i.e., the voltage was substantially constant also). A rest time of approximately 15 minutes was allowed between charge and discharge.

X-ray photoelectron spectroscopy (XPS) was performed using a Scientia Omicron HiPP-3 system using Monochromatic Al Kα rays with approximately 1496.7 eV excitation energy. The X-rays may liberate core-level electrons from an approximately 800 m diameter spot. The kinetic energy photoelectrons may then be measured, and via the photoelectric effect, a plot of photoelectron intensity vs binding energy (BE) may be obtained. The equipment was calibrated to Au 4f₇₂=83.98 eV using argon sputter cleaned gold (Au) foil. Each sample was exposed to ambient air for approximately 30 minutes and then analyzed using approximately 200 eV pass energy and an approximately 500 m slit size in ultra-high vacuum conditions (i.e., approximately 1E-07 mBar). For the scans, adventitious C-C was calibrated to approximately 284.6 eV.

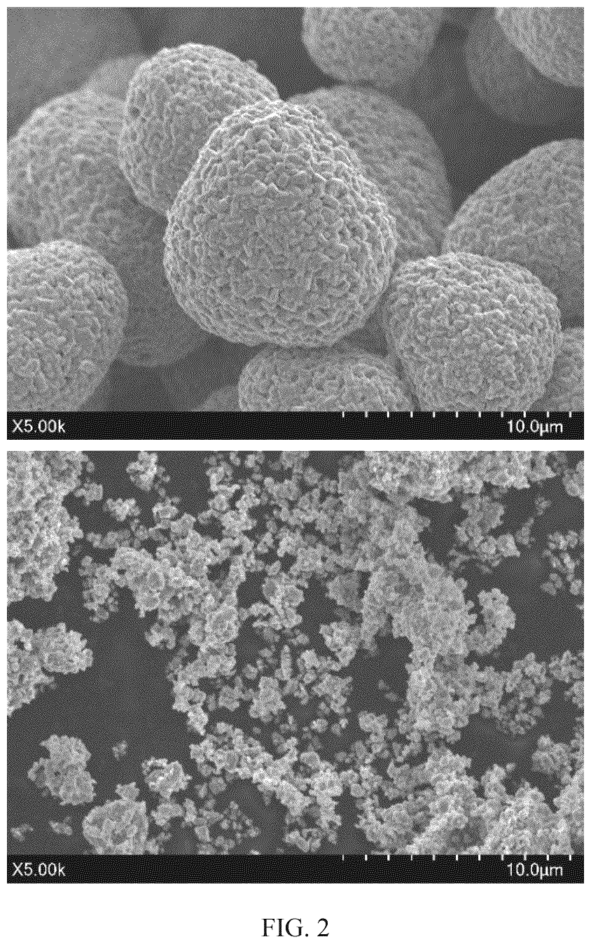

The NMA active material's secondary particles were mechanically pulverized 105, or pre-cracked, along interfaces of the primary particles using a ball-milling technique. A set of gravimetric ratio of cathode active material powder and ceramic balls were placed in a ceramic chamber and run through a planetary ball mill over a set revolution speed and length of time to achieve the appropriate pulverization 105 for this experiment as assessed by SEM (see FIG. 2). In the present disclosure, ball-milling was performed in a substantially inert atmosphere to avoid the formation of residual lithium compounds. Various milling energies were explored to determine the minimal energy possible to successfully pulverize 105 the particle's secondary structure. It was determined that a 1:10 weight ratio of NMA active material to 3 mm zirconia milling media milled at 450 rpm for 75 minutes achieved the desired effect.

FIG. 2 illustrates scanning electron microscope (SEM) images of pulverized NMA cathode materials, according to some aspects of the present disclosure. FIG. 2 (top) shows the pristine NMA's secondary particle structure and (bottom) shows NMA after mechanical pulverization 105 using a ball mill technique. The images in FIG. 2 are to substantially the same scale.

To avoid the negative effects of having large cathode surface areas exposed to electrolyte during electrochemical testing, a lithium phosphate coating was applied 110 to the surface of both the ball-milled and the non-ball-milled materials. The increased capacity retention of lithium phosphate coated material may be attributed to lithium phosphate's relatively high ionic conductivity and its voltage stability (in the range of about 0.0 V to about 4.7 V) (voltages are V in Li/Li⁺), whereas the lithium compounds may impede facile lithium-ion migration. Samples were placed in a beaker containing anhydrous ethanol and phosphoric acid of various concentrations. Starting concentrations of approximately 1 wt % were decreased to approximately 0.4 wt % to allow for a thinner lithium phosphate coating. The ethanol was substantially evaporated at approximately 80° C. while the solution was stirred, and the resulting powder was baked at approximately 500° C. in ambient air.

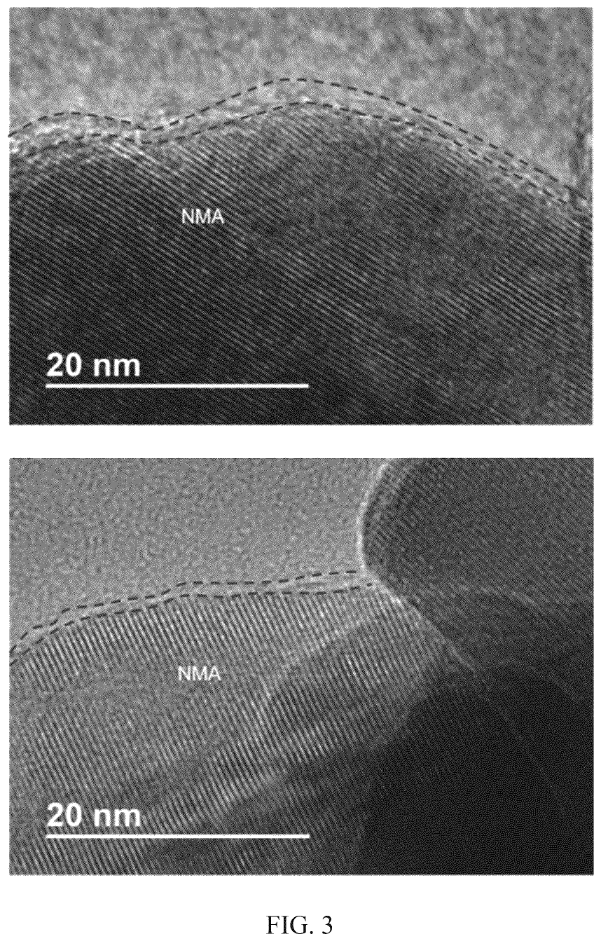

FIG. 3 illustrates transmission electron microscopy (TEM) images of the lithium phosphate coatings on pulverized NMA cathode materials, according to some aspects of the present disclosure. FIG. 3 illustrates NMA having a coating of lithium phosphate. The layered structure of the NMA is in the lower portion of each image (and labeled as such), the relatively thin and nonconformal coating of approximately 3 nm is outlined with dashed lines.

To confirm that lithium phosphate was successfully formed on the NMA's surface, and to gain insight into the coating thickness and uniformity, TEM images were obtained for the coated NMA material (see FIG. 3). The coating thickness ranges from barely detectable to approximately 7 nm and does not appear to be conformal and individual particles can have a large variation of coating thickness. The k-alpha signals of the ball-milled and lithium phosphate-coated sample show a clear phosphorous signal. Spatially, the peak counts aluminum (Al), manganese (Mn), nickel (Ni), and phosphorous (P) closely align, and the particle shape be delineated from the scan, indicating that at least a majority of the NMA particle has at least some phosphate coating. There are clear regions with higher P counts compared with the bulk metal oxide, suggesting a nonuniform coating, in agreement with the TEM scan. Although coating thickness shows large variation, there appears to be P present in the regions where the TMs are found, suggesting at least partial protection for large portions of the NMA surface.

The coated samples were coated with lithium phosphate using varying concentrations of phosphoric acid during the solution coating to apply 110 ever thinner lithium phosphate coatings.

TABLE 1
Sample names and their brief description.

| | | | Lithium phosphate coating |
|---|---|---|---|
| Sample Name | Description | Ball milled | (NMA wt:phosphoric acid wt) |
| P-NMA | Pristine NMA | No | No |
| BM-NMA | Ball Milled NMA | Yes | No |
| C-NMA | Coated NMA | No | Yes (100:1) |
| C-BM-NMA | Ball Milled and coated NMA | Yes | Yes (100:1) |
| TC-NMA | Thinly coated NMA | No | Yes (175:1) |
| TC-BM-NMA | Thinly coated and ball milled NMA | Yes | Yes (175:1) |
| UTC-NMA | Ultra-thinly coated NMA | No | Yes (230:1) |
| UTC-BM-NMA | Ultra-thinly coated and ball milled NMA | Yes | Yes (230:1) |

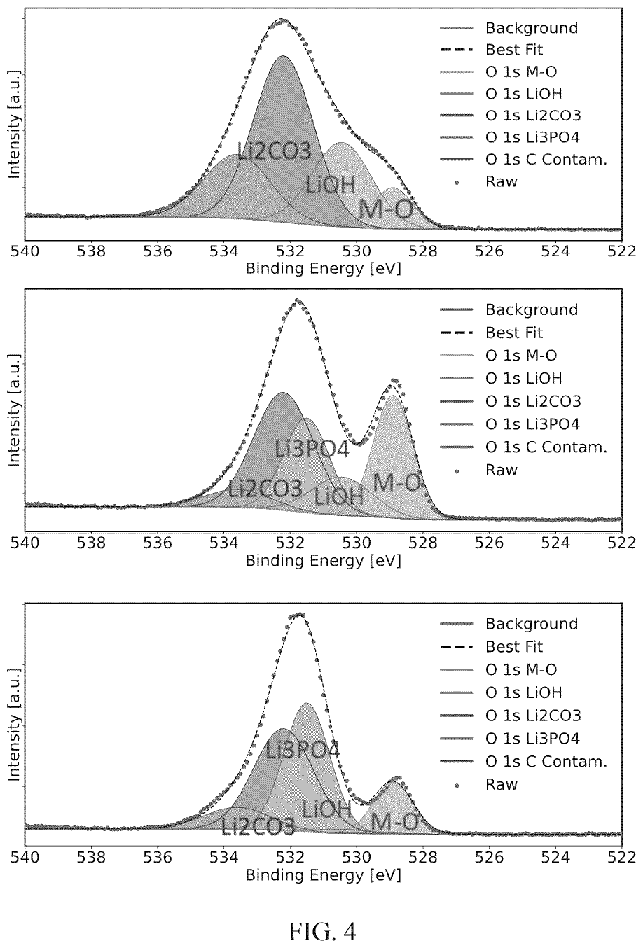

Samples of coated and uncoated NMA were analyzed with x-ray photoelectron spectroscopy (XPS) after approximately 30 minutes of air exposure and prior to cycling. The O 1S XPS peak for the uncoated, BM Li₃PO₄ coated, and the non-BM Li₃PO₄ coated NMA are shown in FIG. 4. The characteristic Li₂CO₃ peak at approximately 532 eV can be seen in the three samples and shifted approximately 0.43 eV for the coated samples toward the lithium phosphate O 1S peak. Panels B and C of FIG. 4 both show the emergence of a fifth oxygen peak at approximately 531.5 eV which corresponds to lithium phosphate and is corroborated by phosphate peaks at approximately 133.6 eV in the P2p scans (not shown). The lattice oxygen (M-O) peak is seen as a shoulder in the uncoated NMA sample and as a distinct peak in the Li₃PO₄ samples. The decreased amount of lithium hydroxide (LiOH) in the UTC-BM-NMA and UTC-NMA accounts for the change in the shape of the M-O peak envelope as the LiGH peak area falls from approximately 29% of the total area to approximately 17% and approximately 3.1% for UTC-BM-NMA and UTC-NMA samples, respectively. The M-O peak is also less intense for the P-NMA due to the uncoated sample having approximately 9% more Li₂CO₃ and in the range of about 12% to about 27% more LiGH than the UCT-BM-NMA and UTC-NMA samples, respectively. Indeed, when considering the peak ratios of CO₃/MO and OH/MO deconvoluted peaks (shown in Table 2) the uncoated sample has more residual lithium compounds, and this suggests that the phosphoric acid consumes these species to form LiPO₄. That is, the lithium phosphate coating appears to increase the air stability of the P-NMA by consuming the residual lithium compounds and converting them into an ionically conductive protective coating. Of the two coated samples, (shown in FIG. 4) both have less Li₂CO₃ and LiGH than P-NMA with the BM material showing more Li₂CO₃ and LiOH. Since both the BM-NMA and the non-ball milled UTC-NMA material were exposed to the same concentration of phosphoric acid, the BM-NMA sample would have less Li₃PO₄ and therefore more residual lithium compounds due to its greater surface area-to-volume ratio.

TABLE 2
Peak ratio levels.

| Peak Ratio | P-NMA | UTC-BM-NMA | UTC-NMA |
|---|---|---|---|
| CO₃/OH | 2.0 | 3.0 | 27 |
| CO₃/MO | 6 | 1.4 | 3.0 |
| OH/MO | 3.0 | 0.5 | 0.1 |

FIG. 5 illustrates electrochemical impedance spectroscopy (EIS) data (i.e., a Nyquist plot) for lithium phosphate coated and uncoated NMA cathode materials after approximately 125 cycles, according to some aspects of the present disclosure. To analyze changes in resistance of the coated material caused by the exposure of differing concentrations of phosphoric acid during the solution coating process (see Table 1), EIS was used after formation at a C/10 rate in the range of about 2.8 V and about 4.4 V in half coin cells (see FIG. 5). A frequency range of about 0.1 Hz to about 1.0 Hz was used with an alternating current perturbation of approximately 10 mV. Measurements are taken at approximately room temperature with an approximately 50% state of charge (SOC). The cells show a solution resistance of approximately 4 Ohm (+/− about 1 Ohm). In coated nickel-rich cathodes the first semicircle in the high-frequency region is assigned to the surface film resistance (R_{sf}) of the solid electrolyte interface (SEI). The BM-NMA material shows the highest R_{sf} (approximately 280 Ohm) with its large surface area-to-volume ratio exposed to electrolyte. The Li₃PO₄ coated samples have a lower R_{sf} resistance which decreases along with the concentration of phosphoric acid, forming ever thinner lithium phosphate layers. The R_{sf} for the UTC-BM-NMA (approximately 23 Ohm) is slightly higher than the P-NMA (approximately 22 Ohm) after formation. The Nyquist plot for the P-NMA, UTC-NMA, and UTC-BM-NMA after approximately 125 cycles is shown in FIG. 5. As the cells have cycled at high voltage the R_{sf} of the P-NMA (approximately 42 Ohm) has increase by about 20 Ohm while the UTC-NMA and UTC-BM-NMA R_{sf} remains unchanged. The R_{ct} for the P-NMA increases by approximately 15% and remains the same for the UTC-BM-NMA after cycling. This could indicate an increase in the SEI thickness for the P-NMA or, since an approximately 50% state of charge was determined by the voltage of the cell just after formation, could be caused by the difference in capacity between the P-NMA and UTC-BM-NMA cells making it difficult to perform EIS at the same state of charge.

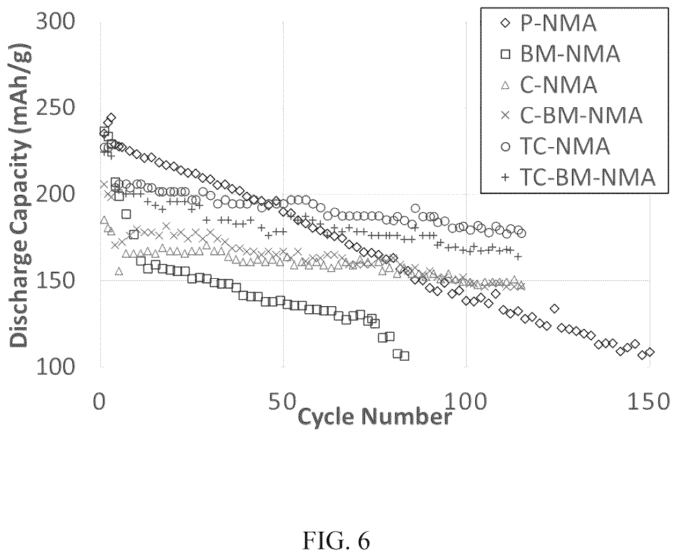

FIG. 6 illustrates initial cycling data for lithium phosphate coated and uncoated NMA cathode materials, according to some aspects of the present disclosure (see Table 1 for the list of samples and their descriptions). The pristine NMA material that did not undergo any mechanical pulverization 105 or coating is referred to as the “P-NMA” sample. The sample that underwent the lithium phosphate coating, but no mechanical pulverization 105 is “C-NMA” and the two balled milled samples, one coated “BM-NMA” and one that was both coated and ball milled “C-BM-NMA.” Half coin cells using this material were first formed at C/10 and then cycled (i.e., utilized 120) at C/3, between about 2.8 V and about 4.4 V (voltages are V vs Li/Li⁺) at approximately room temperature. Initial results for the thicker of the phosphate coatings is seen in FIG. 6. The pristine material has a capacity fade of approximately 43% after about 115 cycles and experiences a voltage decay of approximately 0.23 V. The “C-NMA” has a capacity drop of approximately 17% after about 115 cycles and a voltage decay of approximately 0.14 V. The C-BM-NMA sample experiences a capacity fade of approximately 29% and a voltage decay of approximately 0.23 V. The BM-NMA, having a large surface area-to-volume ratio experiences a large capacity fade and voltage decay. The difference in performance between BM-NMA and C-BM-NMA suggests that it is the surface area-to-volume ratio alone that causes the poor performance of the BM-NMA material, and not crystalline reconstruction due to the mechanical forces experienced during milling. Both the C-NMA and C-BM-NMA have a lower than desired initial capacity, suggesting that lithium is consumed during the coating process.

To increase the initial capacity of the C-NMA samples, a lower concentration of phosphoric acid was used during the solution coating process (see Table 1). These cathode materials were again made into half cells, formed at C/10, and then cycled between about 2.8 V and about 4.4 V (see FIG. 6). The initial capacity of the TC-NMA and TC-BM-NMA increased compared to the C-NMA. The C-NMA and the TC-NMA had first cycle discharge capacity of about 185 mAh/g and about 221 mAh/g, respectively. The initial capacity for the C-BM-NMA and the TC-BM-NMA were about 205 mAh/g and about 223 mAh/g, respectively. However, these are still below the about 234 mAh/g capacity obtained by the P-NMA. When comparing the coated samples, the TC-NMA has a capacity fade of approximately 20% compared to an about 27% fade in the TC-BM-NMA material. Both coated samples maintain more voltage plateau above about 4.0 V during discharge, signaling that they maintain more of their hexagonal H3 phase.

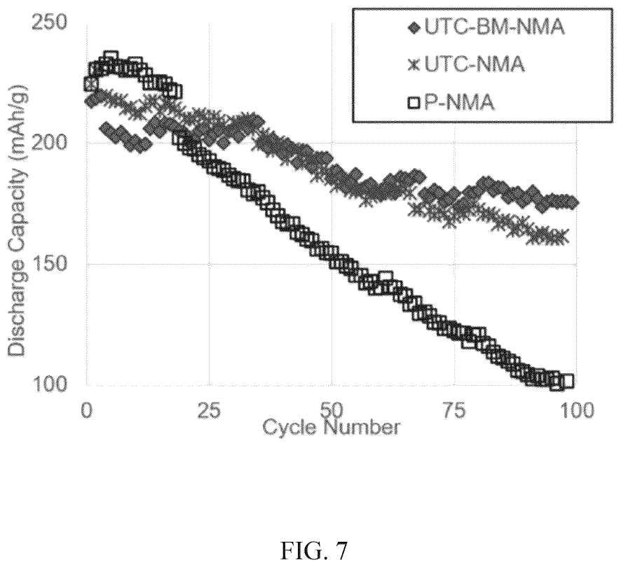

FIG. 7 illustrates half-cell cycling data for lithium phosphate coated and uncoated NMA cathode materials, according to some aspects of the present disclosure. While the thinly coated NMA samples show a marked increase in capacity retention, a final attempt was made to get the coated sample's initial capacity as near as possible to the pristine material. A final round of “ultra-thin” coated samples were made and tested at high voltage with the expectation that the ball milled material, being pulverized 105 or “pre-cracked”, will maintain more of its capacity since nickel-rich cathode cracking often occurs at charge voltages of greater than approximately 4.5 V (V vs Li/Li⁺). The P-NMA, UTC-NMA, and UTC-BM-NMA were first made into half coin cells and formed at C/10 between about 2.8 V and about 4.4 V, then cycled (i.e., utilized) at C/3 between about 2.8 V and about 4.6 V (see FIG. 7). Here, at least a majority of the initial capacity of the P-NMA has been achieved by the UTC-NMA samples. After approximately 100 cycles of C/3 charge to approximately 4.6 V, the UTC-BM-NMA shows the highest capacity of approximately 180 mAh/g, followed by the UTC-NMA at approximately 160 mAh/g, and the P-NMA at approximately 100 mAh/g. The lithium-phosphate coated samples provide protection against capacity fade and voltage decay. The ball-milled sample retains more of its capacity, has less voltage decay, and retains more of its discharge voltage plateau. However, it has a higher-than-expected capacity drop between C/10 and C/3 discharge, possibly due to its higher charge transfer resistance (see FIG. 7).

To analyze the mechanism of lithium loss during the coating process, the thickness of the three coatings can be compared. These cathode materials were made into either half cells or full cells and cycled (i.e., utilized 120) between about 2.8 V and about 4.4 V in Gen-2 electrolytes. In general, the phosphate coated samples have a lower initial capacity than the P-NMA. The lower initial capacity may be a result of lithium diffusion from the cathode particle to form the Li₃PO₄ film or may be caused by lithium evaporation during the heating step of the coating process. To explore this, the exposure of excess phosphoric acid was limited by using varying concentrations of phosphoric acid during the solution process (see Table 1) while maintaining a substantially similar heating temperature and time. The initial specific discharge capacity for the C-NMA, TC-NMA, and UTC-NMA were about 185 mAh/g, about 221 mAh/g, and about 224 mAh/g, respectively. This suggests that the coating process itself removes available lithium from the cathode particles instead of lithium loss caused by evaporation.

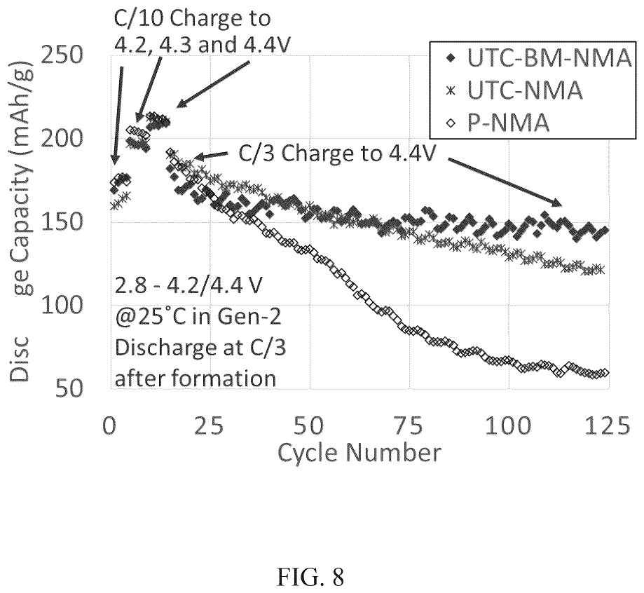

FIG. 8 illustrates full cell cycling data for lithium phosphate coated and uncoated NMA cathode materials, according to some aspects of the present disclosure. Full cells were used to test the coated and ball-milled material performance without the infinite lithium reservoir. NMA full coin cells were made using approximately 90 wt % super P graphite. Cells were initially formed at approximately 4.2 V (V vs. graphite) at C/10 and were then charged to approximately 4.3 V and approximately 4.4 V (V vs. graphite) up to about the tenth cycle. The cells were then charged and discharged at C/3 and the results are shown in FIG. 8. The full cell results follow the same pattern as the half cells, in that both the ball-milled and non-ball milled samples show increased capacity retention when compared to the pristine material. The capacity retention after about 100 cycles at C/3 for the P-NMA, UTC-NMA, and the UTC-BM-NMA samples were approximately 36%, approximately 68%, and approximately 82%, respectively. In addition, the UTC-BM-NMA material shows virtually the same initial C/10 discharge capacity in full coin cells as the pristine material.

The method 100 of the present disclosure include applying 110 a lithium phosphate coating to an NMA cathode material to improve the air stability of the NMA cathode material. The cells demonstrated higher capacity retention and less voltage decay when coated in a protected lithium phosphate coating. These results are further improved by first pulverizing 105 the NMA secondary particles into their individual primary constituents and performing a substantially similar surface treatment. These ball-milled and lithium phosphate coated materials may retain approximately 40% of their discharge capacity compared to pristine materials when charged at high voltage in full cells.

Calendaring is a common industry technique used to maximize the volumetric capacity of battery electrodes by pressing them between two rollers, reducing their porosity. However, at higher amounts of calendaring side effects such as increased tortuosity and electrode brittleness decrease battery function. The method 100 described herein may achieve the benefits of high calendaring (i.e., increased energy density) without the limitations that come with substantial particle deformation. After NMA particles are pulverized 105 into their primary constituents and coated with lithium phosphate, they may be combined 115 with “pristine” NMA particles to form a “bimodal” electrode mixture. The samples were calendared to substantially medium and substantially high porosities. The samples were characterized by X-ray spectroscopy, scanning electron microscopy, electrochemical impedance spectroscopy, and electrochemical cycling. The volumetric and specific capacities were higher for the pristine/unimodal sample (having an approximately 30% porosity), yet the uncalendared bimodal sample specific capacity was slightly higher than the unimodal uncalendared sample. X-ray diffraction showed that the unimodal sample suffered from more particle deformation than the bimodal sample when calendared to approximately the same porosity. Bimodal samples do not require extensive calendaring to achieve a high 30% porosity. When pulverized NMA materials are combined 115 with pristine NMA materials to create a bimodal mixture, the pulverized NMA materials can enter (and in some instances substantially fill) interspatial voids between pristine secondary NMA. In this way, the volume of the cathode may be maximized, and lower amounts of calendaring may be done to achieve relatively low porosities and substantially high volumetric capacities.

In some embodiments, the ratio of pristine NMA to pulverized NMA materials may be approximately 80:20 and used to create an electrode for a lithium-ion battery. A Retsch PM 200 planetary ball mill was employed to pulverize 105 the NMA into its primary constituents. An approximately 1:10 weight ratio of NMA (approximately 5 g) to ZrO₂ beads (approximately 50 g) were inserted into a ZrO₂ vessel (approximately 25 mL) in an Argon atmosphere. The milling procedure included spinning at approximately 450 rpm, grinding and rest times of approximately 60 and approximately 20 s, respectively, and a reverse of rotation after each rest. There was an operational time of approximately 75 minutes.

After pulverization 105, the primary particles were given lithium phosphate coatings using a diffusion-controlled reaction of phosphoric acid in ethanol. Phosphoric acid and pristine NMA were mixed with anhydrous ethanol in an Argon atmosphere. The solution was stirred and brought to approximately 85° C. until the solvent evaporated. The dried powder was loaded into a tube furnace and heated to approximately 500° C. for approximately 5 hours in air.

For the bimodal mixture, an approximately 80:20 ratio of unpulverized (approximately 2.4 g) to coated pulverized (approximately 0.6 g) NMA was weighted in an Argon atmosphere. The unimodal mixture was approximately 3.0 g of pristine NMA weighted in an Argon atmosphere. Each mixture (approximately 92 wt %) was mixed with approximately 0.130 g of carbon black (approximately 4 wt %) and approximately 5.22 g polyvinylidene fluoride (PVDF) in n-methyl-pyrrolidone (NMP) or approximately 0.130 g PVDF (approximately 4 wt %). The slurry was coated onto an aluminum foil in air using a doctor blade at a thickness of approximately 30 m and placed in a vacuum oven to be dried overnight at room temperature. Electrode punches were approximately 14 mm in diameter and had a loading of approximately 2.5 mAh/cm². Uncalendared electrodes had a thickness of approximately 0.080 mm and approximately 69% porosity.

The calendar was washed with Isopropanol prior to each use. Electrodes were cut into rectangular strips such that no Aluminum was exposed. To calculate the porosities of the samples, Eqn. 1 was used. The theoretical density of NMA (ρ_{theoretical}) was determined using a liquid displacement method. To a graduated cylinder 3 mL of water and 1.2 g of NMA was added. The mass of NMA added divided by the volume change (in mL) of water in the cylinder gave a theoretical capacity of 5.92 g/cc. The measured electrode thickness (ρ_{electrode}) was determined by measuring the mass and thickness of 14 mm diameter cathode punches. Measuring the thickness of different parts of the punch with the micrometer and averaging them was done if different thicknesses were present on the same punch. To obtain the thickness and mass of the Aluminum, NMP was used to remove the material. Measuring the thickness of different parts of the Aluminum punch and averaging them was also done.

$$ε = ( 1 - \frac{{ρ}_{electrode}}{{ρ}_{theoretical}} ) \times 100 \% \qquad Eqn . 1$$

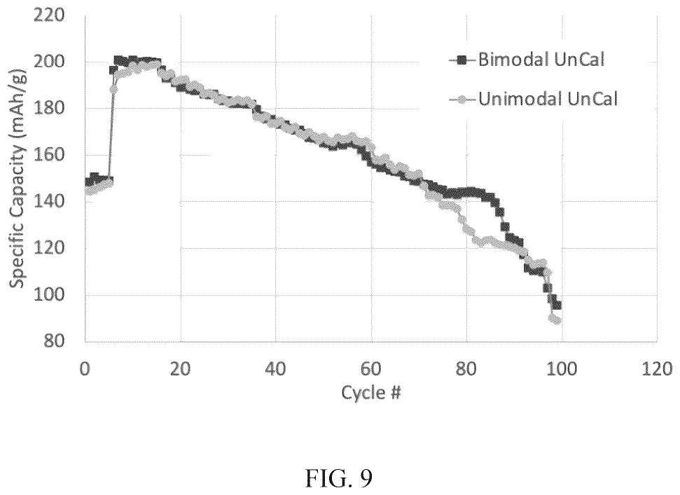

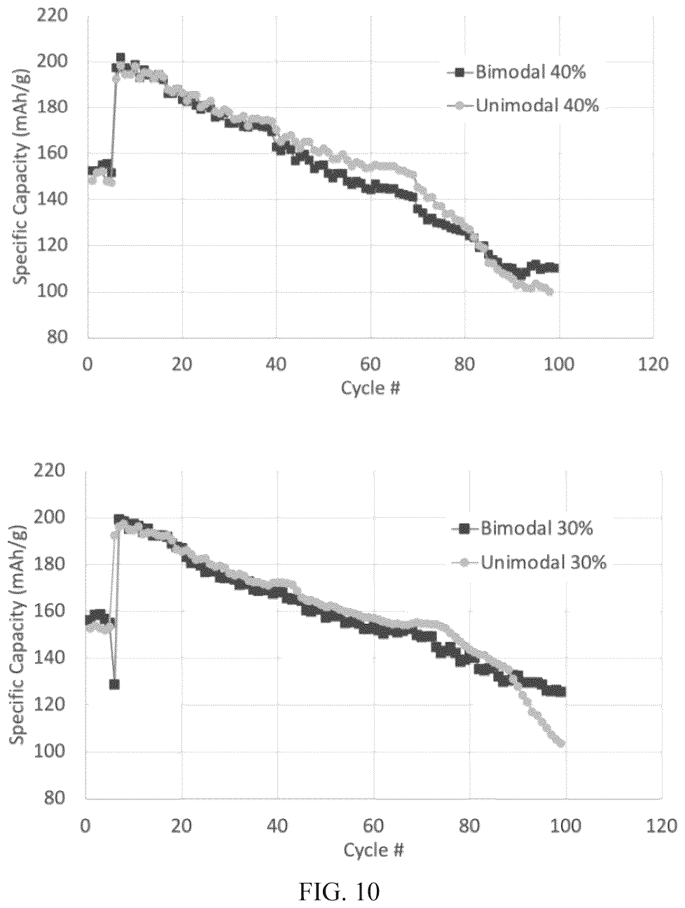

Electrodes were assembled into half cells in an Argon glovebox with less than approximately 0.1 ppm water and O₂. Cell parts and lithium metal was obtained from MTI Corp. The cells were assembled using approximately 60 μL of the Gen-2 electrolyte (approximately 1.2 M lithium hexafluorophosphate (LiPF₆) in a mixed solvent of ethylene carbonate ethyl methyl carbonate (approximately 3:7 by weight)). Formation occurred at C/10 charge/discharge rates at a current of approximately 0.0002 Ah from approximately 2.8 to approximately 4.2 V and subsequent cycling occurred at C/3 at a current of approximately 0.0006 Ah from approximately 2.8 to approximately 4.5 V. Electrode samples were cut into approximately 8×8 mm pieces. Sandwiched between Si wafers and cut using an Argon ion mill to obtain cross-section. Samples then imaged using SEM. X-ray diffraction (XRD) data were acquired and copper radiation and a K-beta (Kβ) filter. The samples were cut into square pieces and taped onto the glass slide with double-sided tape. Results are shown in FIGS. 9 and 10.

FIG. 9 illustrates specific capacity as a function of the cycle number for substantially uncalendared bimodal and unimodal cells, according to some aspects of the present disclosure. FIG. 10 illustrates specific capacity as a function of the cycle number for approximately 40% calendared (top), and approximately 30% calendared (bottom) bimodal and unimodal cells, according to some aspects of the present disclosure. Half cells were first formed at C/10 from approximately 2.8 to 4.4 V for five cycles and then at C/3 from 2.8 to 4.5 V at RT. FIG. 9 shows capacities are similar for the unimodal and bimodal uncalendared samples, with an increase in the capacities at around cycle 80. FIG. 10 (top) shows slightly lower specific capacities for the bimodal samples from cycle 40-80. But the capacities at the end of cycling are higher in the bimodal sample, suggesting better capacity retention. The same is observed in FIG. 10 (bottom) where despite higher amounts of calendaring in the unimodal sample the bimodal sample still exhibits similar capacities throughout cycling and an increased capacity at higher cycling compared to the unimodal sample.

The approximately 40% unimodal and bimodal samples were closer in thicknesses at approximately 0.043 mm and approximately 0.042 mm, respectively. Although high-nickel cathode particles break during calendaring, the similar thicknesses at approximately 40% porosity may be due to the compression of pockets of air or inactive material composite in the cathode at low and medium levels of calendaring. It should be noted that calendaring from initial electrode thicknesses (approximately 0.076 mm) to approximately 0.050 mm was quick and undemanding compared with the effort that it took to achieve thicknesses lower than that. At high levels of calendaring (less than approximately 0.040 mm), particle smashing becomes more prevalent and negative side effects such as electrode cracking were observed. It is expected that the approximately 40% bimodal sample will have a larger volumetric capacity than the unimodal sample because the samples are being compared at about the same thicknesses. This should allow for a fair comparison of the effects of particle packing on volumetric capacity.

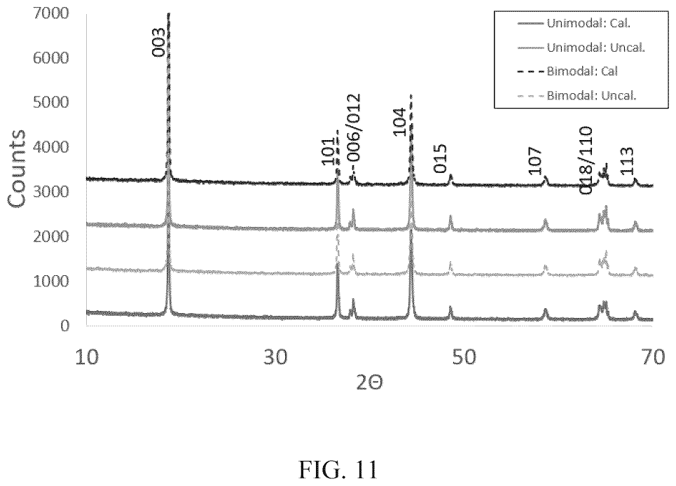

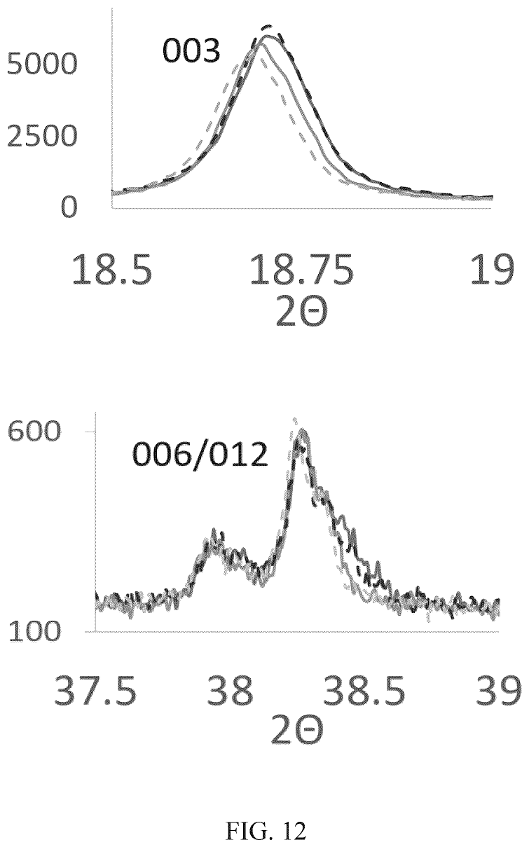

Phase purity of the unimodal and bimodal samples were compared at uncalendared and approximately 30% porosities. XRD revealed that the samples have a hexagonal α-NaFeO₂-type structure of the R3̅m space group. The samples were phase pure. FIG. 11 shows high crystallinity of the four samples, as the peaks are clearly defined rather than appearing broad and merged. FIG. FIG. 12 (top) shows how calendared samples have a slight shift towards larger angles of 2θ. FIG. 12 illustrates XRD data comparing unimodal and bimodal uncalendared and calendared (approximately 30% porosities) samples at 003 (top) and 006/012 (bottom) peaks, according to some aspects of the present disclosure. This shift in the calendared samples were observed in the peaks and is likely due to the different surface textures of calendared and uncalendared samples. Uncalendared electrodes have a textured surface and after calendaring electrodes develop a smooth finish. This may have led to sample misalignment in the XRD.

A smaller full width at half maximum (FWHM) and a larger crystal size for the unimodal uncalendared samples was observed when compared to the bimodal uncalendared samples. This is because the bimodal mixture contains smaller primary particles while the unimodal mixture does not. Interestingly, the unimodal crystal size was smaller than the bimodal sample after calendaring as indicated by a larger FWHM. This suggests that there was a larger amount of particle crushing and deformation with calendaring for the unimodal sample to achieve the same porosity. Electrochemical cycling imposes strain on the particles over time, and particle cracking due to calendaring may enhance the rate of this fracturing. Beyond increased breaking stress, ionic Li⁺ transport and electronic pathways may be compromised for cracked particles. An integrated intensity ratio of approximately I(003)/I(104) shows the degree of cation mixing between Ni⁺ and Li⁺ ions. The XRD of the bimodal sample exhibited a slightly higher degree of cation mixing (1.30) than the unimodal sample (approximately 1.33). This cation mixing may be due to structural damage of the pulverized particles from the coating procedure, which involved drying the material at approximately 500° C. for 5 hours and rigorous mixing on a hot plate at approximately 85° C.

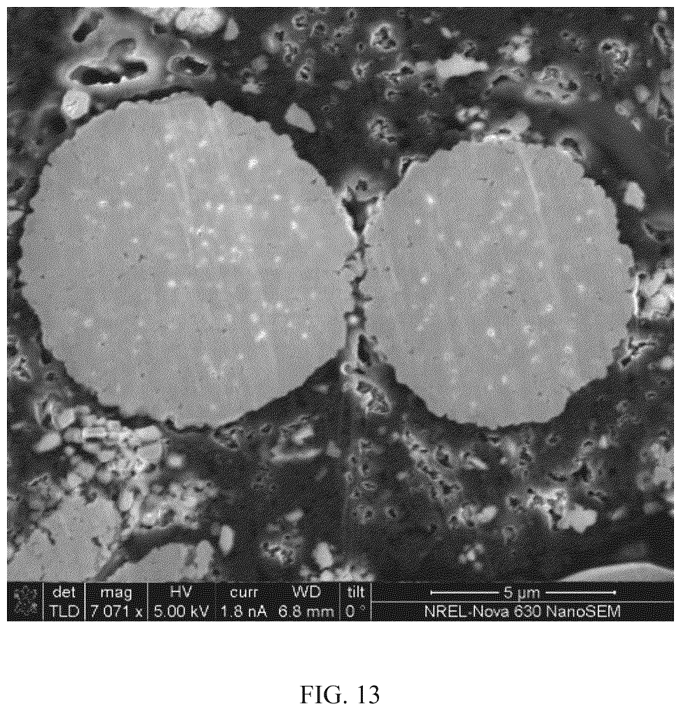

Images were obtained via focused ion beam SEM with Argon. FIG. 13 illustrates a focused ion beam cross-sectional SEM image of an approximately 30% calendared bimodal NMA cathode material, according to some aspects of the present disclosure. FIG. 13. shows the pulverized particle distribution in the PVDF-carbon matrix. It seems that clumps of primary particles create small pockets of air even at 30% porosity, which explains why the initial thickness of the bimodal electrodes is larger than the unimodal electrodes and why bimodal electrodes calendar with less effort. FIG. 13 also shows the beginnings of secondary particle fusion. It is accepted that the penetration of electrolyte into fused particles is difficult, which limits bulk liquid mass transport.⁴

FIG. 13 shows a relatively even primary particle distribution in the black matrix, although some areas are sparser. The secondary particles are fractured, and these cracks will propagate with increased calendaring which will continue to break the particle into its smaller primary particles. These free primary particles are now exposed to electrolyte and susceptible to parasitic side reactions. Unlike the pulverized primary particles obtained through ball-milling, they are not coated in protective lithium phosphate.

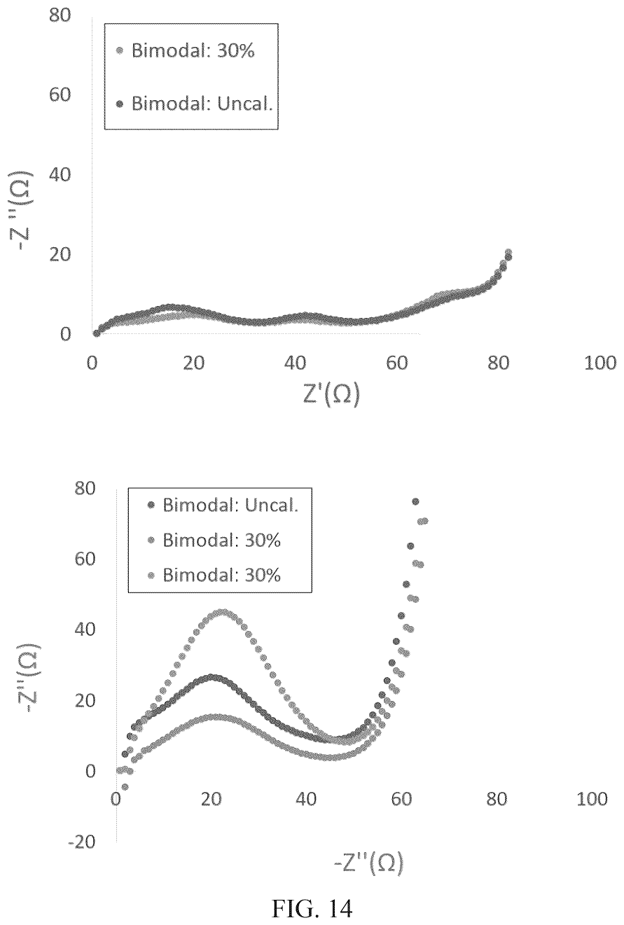

To analyze changes in the resistance of bimodal calendared cells, electrochemical impedance spectroscopy (EIS) was used after formation at a C/10 rate between approximately 2.8 and approximately 4.4 V in half coin cells. A frequency range of approximately 0.001 Hz to approximately 0.1 MHz was used with an AC and measurements were taken at approximately room temperature. The first semicircle in FIG. 14 decreases for the approximately 30% calendared cell, whereas the opposite is observed in the unimodal cells. In coated Ni-rich cathodes, the first semicircle represents the surface film resistance of the solid electrolyte interface (SEI). The decrease of this semicircle supports lower amounts of SEI formation, despite calendaring creating primary particles which provides additional surface area for electrolytic decomposition and additional SEI formation. The hump closest to the Warburg tail exhibits increased resistance with calendaring but is less pronounced for the bimodal samples than the unimodal ones. This may be due to the increased electrode tortuosity with calendaring which hinders Li ion diffusion. FIG. 14 (bottom) shows an inconclusive trend for the approximately 30% bimodal samples after calendaring. One sample exhibits an impedance like that of the unimodal sample after approximately 100 cycles and the other sample exhibits decreased impedance compared to the uncalendared sample.

FIG. 14 illustrates a Nyquist plot of bimodal calendared and approximately 30% uncalendared half cells after the fifth formation cycle (top) and after approximately 100 cycles (bottom), according to some aspects of the present disclosure. The approximately 30% unimodal samples after the fifth cycle exhibit increased impedance for the first semicircle, where the opposite is observed in the bimodal samples. The impedance is slightly larger near the Warburg tail compared to that of the bimodal samples. Interestingly, rather than the impedance increasing exponentially at Z′(Ω)=60Ω, the plot proceeds to trace a second semicircle. This is different than the bimodal samples which do not show a second semicircle.

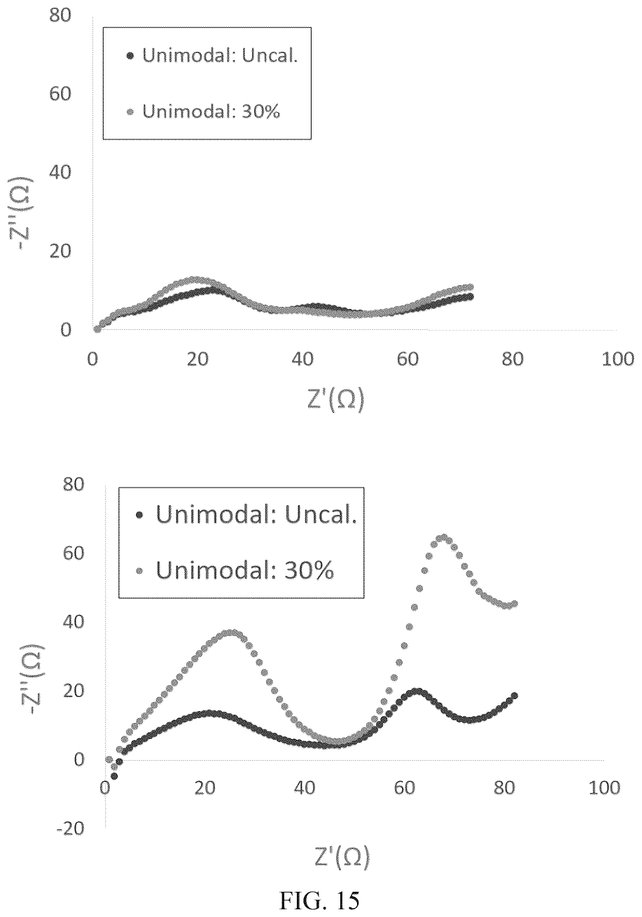

FIG. 15 illustrates a Nyquist plot of unimodal approximately 30% calendared and unimodal uncalendared half cells after the fifth formation cycle (top) and after approximately 100 cycles (bottom), according to some aspects of the present disclosure.

In this present disclosure, a bimodal electrode composed of pulverized, primary NMA and typical NMA was benchmarked against a typical NMA electrode, deemed the unimodal electrode. Less effort is used to calendar bimodal electrodes, potentially due to the air pockets induced by the unique particle packing. This limits particle damage as supported by the larger FWHM for the calendared unimodal sample when compared to the calendared bimodal sample. After calendaring, the resistance is decreased for the bimodal samples after about the first five cycles. It is demonstrated that the bimodal particle configuration uses less extensive calendaring to achieve high porosities and exhibits less particle damage compared to typical electrodes. The capacity retention of calendared bimodal samples has proven to be larger when compared to the unimodal samples, suggesting increased stability of the particles due to the unique packing

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present disclosure, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A method comprising:
pulverizing a pristine LiNi_{0.9}Mn_{0.5}Al_{0.05}O₂(NMA) cathode material resulting in a pulverized NMA cathode material; and
applying a coating on the pulverized NMA cathode material resulting in a coated pulverized NMA cathode material.

2. The method of claim 1, further comprising:
combining the coated pulverized NMA cathode material with the pristine NMA cathode material resulting in a bimodal NMA cathode material.

3. The method of claim 2, further comprising:
utilizing the bimodal NMA cathode material in a lithium-ion battery.

4. The method of claim 3, wherein:
the lithium-ion battery retains at least 50% of its capacity retention after 100 cycles at C/3.

5. The method of claim 4, wherein:
the lithium-ion battery retains at least 80% of its capacity retention after 100 cycles at C/3.

6. The method of claim 2, wherein:
the bimodal cathode material comprises the pristine NMA cathode material and the coated pulverized NMA cathode material combined in a ratio in the range of about 50:50 to about 95:5.

7. The method of claim 6, wherein:
the bimodal cathode material comprises the pristine NMA cathode material and the coated pulverized NMA cathode material combined in a ratio of approximately 80:20.

8. The method of claim 1, further comprising:
utilizing the coated pulverized NMA cathode material in a lithium-ion battery.

9. The method of claim 1, wherein the pulverizing comprises:
grinding the pristine NMA cathode material using a ball mill.

10. The method of claim 1, wherein the pulverizing comprises:
grinding the pristine NMA cathode material using a roller mill.

11. The method of claim 1, wherein the pulverizing comprises:
crushing the pristine NMA cathode material.

12. The method of claim 1, wherein the applying comprises:
exposing the pulverized NMA cathode material to phosphoric acid, wherein:
the exposing results in the coating comprising lithium phosphate to be present on the pulverized NMA cathode material.

13. The method of claim 1, wherein the applying comprises:
using vapor deposition to deposit the coating on the pulverized NMA cathode material.

14. The method of claim 1, wherein the coating comprises at least one of lithium phosphate, aluminum oxide, or aluminum fluoride.

15. A lithium-ion battery device comprising:
a cathode comprising a coated pulverized NMA cathode material.

16. The device of claim 15, wherein:
the lithium-ion battery retains at least 50% of its capacity retention after 100 cycles at C/3.

17. The device of claim 16, wherein:
the lithium-ion battery retains at least 80% of its capacity retention after 100 cycles at C/3.

18. The device of claim 15, wherein:
the cathode further comprises a pristine NMA cathode material, resulting in a bimodal cathode material.

19. The device of claim 18, wherein:
the bimodal cathode material comprises the coated pulverized NMA cathode material and the pristine NMA cathode material in a ratio in the range of about 50:50 to about 95:5.

20. The device of claim 18, wherein:
the bimodal cathode material comprises the coated pulverized NMA cathode material and the pristine NMA cathode material in the ratio of approximately 80:20.
